(19) United States
(12) Patent Application Publication
(10) Pub. No.: US 2009/0152293 A1
(43) Pub. Date: Jun. 18, 2009

(54) Counter-mounted solution dispenser with counter-protective platform

(76) Inventors: Richard C. Sayers, Akron, OH (US); Shane Obitts, Elyria, OH (US)

Correspondence Address: Mark L. Weber, Fourth Floor, First National Tower, Akron, OH, 44308-1456, US

(21) Appl. No.: 12/001,244

(22) Filed: Dec. 12, 2007

(51) Int. Cl. B67D 5/08; B67D 5/64

(52) U.S. Cl. 222/52; 222/173

(57) ABSTRACT

A dispensing station is mounted to a counter and includes a container that is retained under the counter to hold a volume of no-rinse hand-treatment product. A protective platform is positioned on the top surface of the counter, and a faucet structure has an outlet positioned over the protective platform. A pump communicates with the volume of no-rinse hand-treatment product in the container, and a dispensing conduit extends through the faucet structure, communicating between the pump and the outlet of the faucet structure such that actuation of the pump causes no-rinse hand-treatment product to be dispensed at the outlet and directed toward the protective platform. This dispensing station will encourage the use of no-rinse hand-treatment products by providing a well-defined station, similar to the stations defined by common sinks.

### TECHNICAL FIELD

The present invention generally relates to counter-mounted solution dispensers, and, more particularly, relates to a counter-mounted solution dispenser that defines a dispensing station having a counter-protective platform intended for use with no-rinse solutions.

### BACKGROUND OF INVENTION

Dispensers for soap and other hand-treatment products are often times provided adjacent to a sink basin having a faucet such that an individual can wash or otherwise treat his hands at the sink. At these dispensers, soap or other hand-treatment product is dispensed to the hand and rinsed away by using the faucet at the sink. Various types of sink-side dispensers are provided, including those that must be physically manipulated to dispense product, and those that dispense product through touchless sensors. These dispensers can employ various pumping mechanisms. Some examples include those taught in published U.S. Patent Application No. 2007/0017932.

A sink with a dispenser mounted adjacent thereto provides a well-defined station for treating one's hands. Additionally, dirt and drips of soaps or other hand-treatment products go into the sink basin preventing the counter surface from being unnecessarily soiled. The sink basin includes a drain, and any product in the basin can be rinsed down the drain by operating the faucet.

No-rinse hand-treatment products need no rinse water and, therefore, dispensers of no-rinse hand-treatment products are not typically mounted adjacent a sink basin. Instead no-rinse hand-treatment products are typically provided in portable bottles or in wall-mounted dispensers. No-rinse hand-treatment products are generally known in the art, and can include any hand-treatment product that does not need to be rinsed off of one's hands. Lotions and sanitizers are very common examples.

The present invention seeks to provide a well-defined station for the use of no-rinse, hand-treatment products, particularly in a counter-mounted environment. In this way, the present invention seeks to provide well-defined stations that will encourage the use of no-rinse hand-treatment products.

### SUMMARY OF THE INVENTION

In one embodiment, the present invention provides a dispensing station mounted to a counter wherein a container is retained under the counter and holds a volume of no-rinse hand-treatment product. A protective platform is positioned on the top surface of the counter, and a faucet structure has an outlet positioned over the protective platform. A pump communicates with the volume of no-rinse hand-treatment product in the container, and a dispensing conduit extends through the faucet structure, communicates between the pump and the outlet of the faucet structure such that actuation of the pump causes no-rinse hand-treatment product to be dispensed at the outlet and directed toward the protective platform.

### DESCRIPTION OF THE DRAWINGS

FIG. 1 is a perspective view showing portions of the dispensing station of this invention as viewed on top of a counter;

FIG. 2 is a side elevation view of the dispensing station, showing portions both above and below a counter;

FIG. 3 is an assembly diagram of the dispensing station of FIGS. 1 and 2; and

FIG. 4 is a perspective view of a second embodiment of a dispensing station in accordance with this invention.

### DETAILED DESCRIPTION OF THE INVENTION

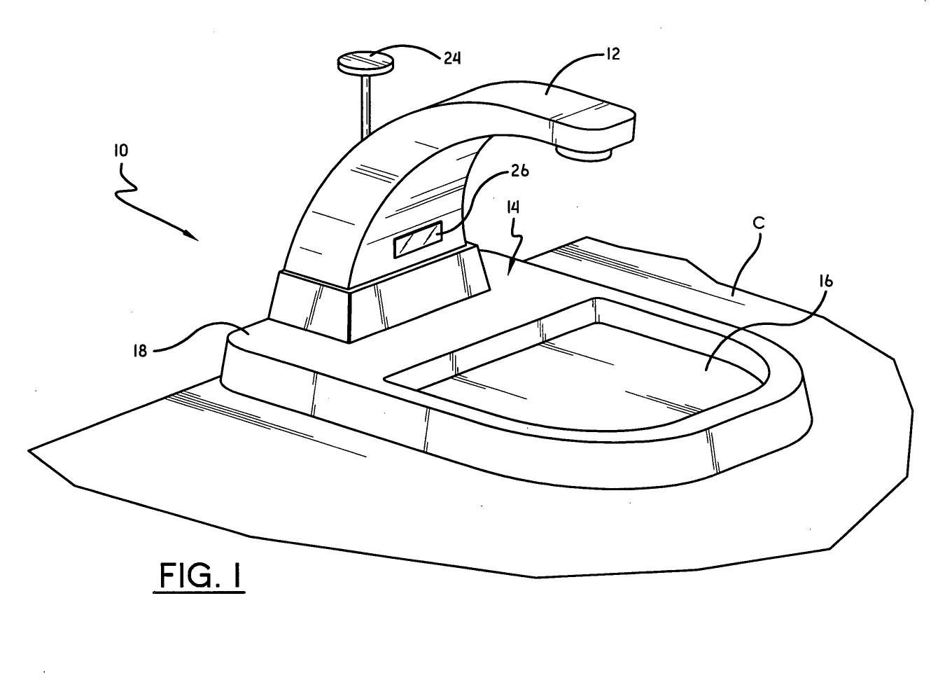

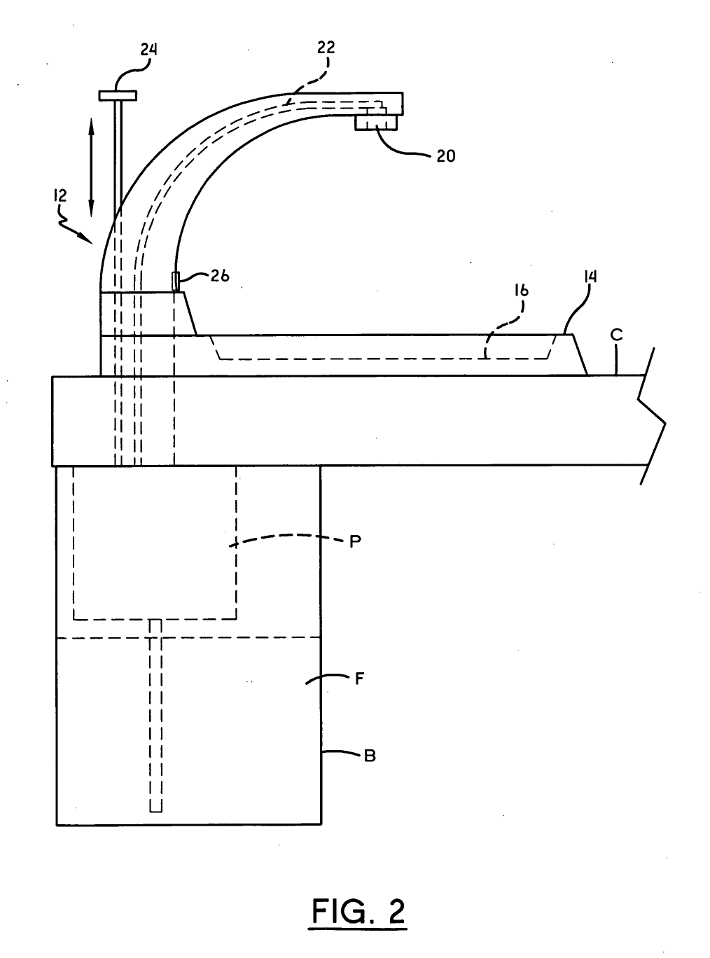

Referring now to FIGS. 1-3, a first embodiment of a dispensing station in accordance with this invention is shown and designated by the numeral 10. The dispensing station 10 is securely mounted to a counter C, and includes a faucet 12 mounted to extend over a protective platform 14, which sits on top of counter C. The protective platform 14 preferably includes a faux basin 16, which is simply a concavity in the top surface 18 of the protective platform 14 that replicates a sink. The faux basin 16 is aligned with an outlet 20 in faucet 12 so that it will receive any drips of product from the outlet 20 of faucet 12. A dispensing tube 22 provides or communicates with outlet 20 at one end, and extends within faucet 12, through counter C, to communicate with pump mechanism P, which is preferably retained under the counter C so that it is out of sight, as is generally practiced in the art of counter-mounted dispensers. Pump P is actuated in a known manner, either through the depression of a plunger 24 or the actuation of a touchless dispensing sensor 26 or otherwise as generally known in the art. More particularly, this invention is not particularly concerned with the manner of actuating pump P to dispense product, and, thus, reliance is placed on the fact that these pump, plunger and touchless sensor-based dispensing mechanisms and their substitutes are known to those of skill in the art.

Pump P is actuated to advance fluid F from a bottle B through dispensing tube 22 to outlet 20. The fluid is particularly selected to be no-rinse hand-treatment product inasmuch as protective platform 14 does not provide a drain for product that is to be rinsed from the hands when used. Fluids that would be employed in the dispensing station of this invention include but are not limited to hand sanitizers, lotions, sunscreens, no-rinse hand cleaners, and the like. Because these types of no-rinse products are not intended to be rinsed away, they have typically been provided in portable or wall-mounted dispensers. In the present invention, products can be presented for the end user in a very stylish manner, mimicking the common sink-side counter-mounted dispenser combinations of the prior art. The faux basin both protects the counter and identifies a station at which an end user can obtain a dose of a no-rinse product for use. Because no-rinse products are the focus, the protective platform 14 may be devoid of a drain. Providing such a well-defined and stylish dispensing station 10 will help encourage the use of the no-rinse product being offered. In the case of hand sanitizers, the use of the dispensing station of this invention may greatly increase the hand hygiene at a given establishment.

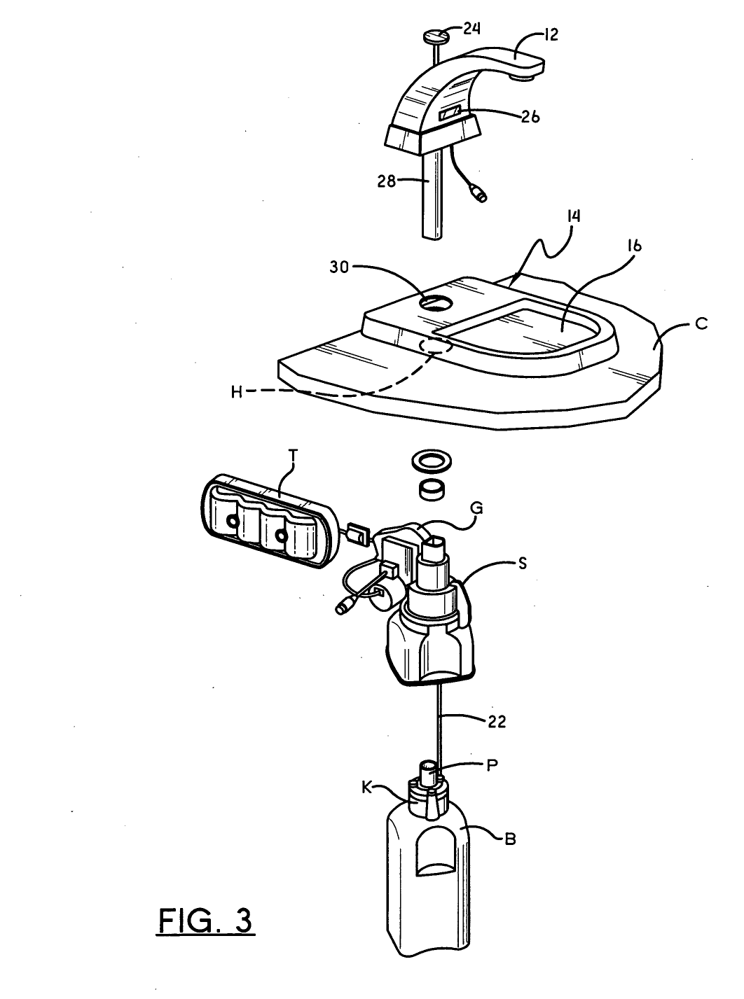

With respect to FIG. 3 it can be seen that faucet 12 includes an extension 28 that extends through a mount aperture 30 in protective platform 14, aligned with a through hole H in counter C. This extension 28 is secured to pump P or bottle B or both, through any known or desired method and can carry elements for actuating pump P through a plunger 24 or for actuating pump P through touchless sensor technology. In FIG. 3, structure similar to that taught in pending U.S. Published Application 2007/0017932 is particularly shown, but, as already mentioned above, this invention is not intended to be limited to or by any particular pump, bottle or faucet structure or interaction or actuation. In FIG. 3, bottle support S secures above-counter elements to below-counter elements. Particularly, bottle support S is secured to extension 28 and to a collar key K secured to pump P and bottle B as shown in U.S. 2007/0017932, and touchless sensor 26 is activated to advance gearing structures G, powered by batteries T to actuate pump P.

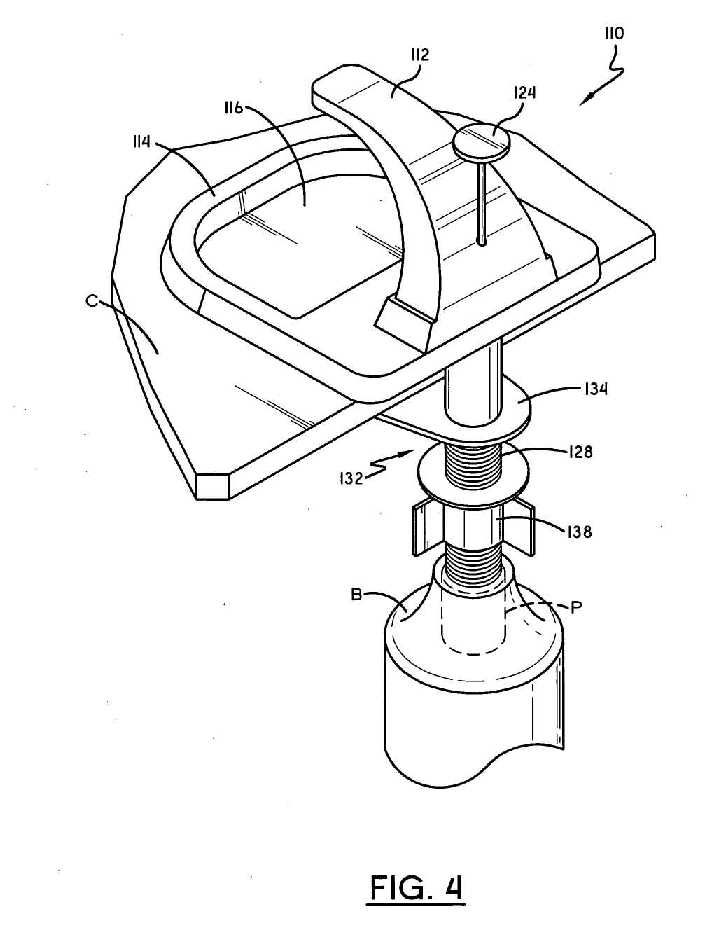

Referring now to FIG. 4, another embodiment of a dispensing station in accordance with this invention is shown and designated by the numeral 110. In this embodiment, the dispensing station 110 is readily portable and capable of being secured to the edge of a counter C. As with the first embodiment of dispensing station 10, dispensing station 110 includes a dispensing faucet 112 mounted to extend over a protective platform 114, which is intended to sit on top of a counter C. A plunger 124 or touchless sensor mechanism (not shown) could be employed to actuate a pump mechanism P held in bottle B. In this embodiment, an extension 128 of the faucet 112 is adapted to receive clamp mechanism 132 to secure the dispensing station 110 to the edge of a counter C. The protective platform 114, particularly the faux basin 116 portion, is placed on top of the counter, with the extension 128 of faucet 112 extending downwardly past the edge and below the counter C. A clamp plate 134 includes an aperture 136 through which extension 128 extends and this clamp plate 134 is advanced towards the bottom of counter C by means of clamp nut 138. Extension 128 is threaded so as to interact with threads on nut 138. The dispensing station 110 will be secured to the counter C when the counter C is clamped between the protective platform 114 and the clamp plate 134. Other suitable structures for permitting use of this invention without providing a hole in a countertop will be apparent given the teachings herein.

In order to properly focus attention on the particular advancements offered by the present invention, only those elements which pertain to the present invention have been disclosed in detail. Other elements of the pumping mechanics are generally known in the art and can be adapted for a desired type of pump mechanism and bottle. While in accordance with the patent statutes only the preferred embodiments have been described herein, the present invention is not limited thereto or thereby, and the true scope of this invention shall be appreciated from the following claims.

1. A dispensing station mounted to a counter and comprising:
a container retained under the counter and holding a volume of a no-rinse hand treatment product;
a pump communicating with the volume of no-rinse hand treatment product in said container;
a protective platform positioned on a top surface of the counter;
a faucet having an outlet positioned over said protective platform; and
a dispensing conduit extending through said faucet and communicating between said pump and said outlet of said faucet such that actuation of said pump causes no-rinse hand-treatment product to be dispensed at said outlet.

2. The dispensing station of claim 1, further comprising a mount aperture in said protective platform, wherein the counter includes a through hole aligned with said mount aperture and wherein said faucet includes an extension, said extension extending through said through hole and said mount aperture.

3. The dispensing station of claim 1, further comprising a plunger for actuating said pump to dispense said no-rinse hand treatment product.

4. The dispensing station of claim 1, further comprising a sensor for actuating said pump to dispense said no-rinse hand treatment product.

5. The dispensing station of claim 1, wherein said protective platform replicates a sink and is devoid of a drain.

6. The dispensing station of claim 1, wherein said protective platform provides concavity, and said outlet of said faucet is positioned over said concavity.

7. The dispensing station of claim 1, further comprising a clamp mechanism securing the dispensing station to an edge of the counter.
